(19) United States
(12) Patent Application Publication
(10) Pub. No.: US 2010/0020975 A1
(43) Pub. Date: Jan. 28, 2010

(54) SYSTEM AND METHOD FOR ELECTRONIC DATA SECURITY

(75) Inventor: James Bissett, Singapore (SG)

Correspondence Address: HEWLETT-PACKARD COMPANY;Intellectual Property Administration, 3404 E. Harmony Road, Mail Stop 35, FORT COLLINS, CO, 80528, US

(73) Assignee: Electronic Data Systems Corporation, Plano, TX (US)

(21) Appl. No.: 12/179,279

(22) Filed: Jul. 24, 2008

(51) Int. Cl. H04L 9/08; H04K 1/00

(52) U.S. Cl. 380/270; 380/283

(57) ABSTRACT

A method and related secure communications system. The method includes detecting, by a base station, a mobile device docked with the base station and in response to the detecting, generating at least one encryption key in the base station. The method also includes transmitting the encryption key to the mobile station by the base station while the mobile device is docked with the base station. The method also includes communicating encrypted data with the mobile station, the encrypted data corresponding to the encryption key.

### TECHNICAL FIELD

The present disclosure is directed, in general, to data security and, more specifically, to encryption for mobile devices.

### BACKGROUND OF THE DISCLOSURE

Data intrusion is a serious threat. As mobile devices become more prevalent, security of communications with the mobile devices becomes more important.

### SUMMARY OF THE DISCLOSURE

Various disclosed embodiments include a method. The method includes detecting, by a base station, a mobile device docked with the base station and in response to the detecting, generating at least one encryption key in the base station. The method also includes transmitting the encryption key to the mobile station by the base station while the mobile device is docked with the base station. The method also includes communicating encrypted data with the mobile station, the encrypted data corresponding to the encryption key.

Another disclosed embodiment includes a secure communications system comprising a base station and a mobile station. The base station configured to perform the steps of detecting a mobile device docked with the base station and in response to the detecting, generating at least one encryption key. The base station is also configured to perform the step of transmitting the encryption key to the mobile station by the base station while the mobile device is docked with the base station; and communicating encrypted data with the mobile station, the encrypted data corresponding to the encryption key.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a simplified block diagram of a base station in communication with a mobile device, in accordance with a disclosed embodiment; and

FIG. 3 depicts a flowchart of a process in accordance with a disclosed embodiment.

### DETAILED DESCRIPTION

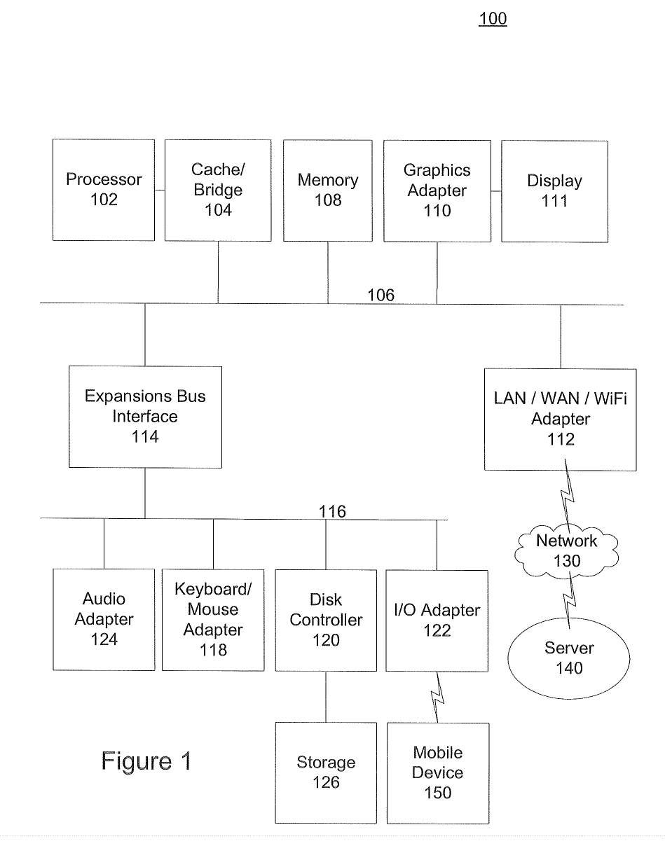

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Mobile device 150 is shown in communication with I/O adapter 122. Mobile device 150, as described herein, can be any mobile device capable of communicating with data processing system 100, including but not limited to mobile telephones, scanners, personal digital assistants (PDAs), music players, multifunction devices, other portable computer systems pagers, etc. Mobile device 150 can also be a special-purpose device, such as a weapon system, unmanned aerial vehicle, robot, or other.

The communication between mobile device 150 and I/O adapter 122 can be accomplished by any known communications means, including but not limited to wired serial or parallel communications over any number of known buses, wireless communications such as infrared, Bluetooth, WiFi, and other radio-frequency communications, and others. The communication between mobile device 150 and I/O adapter 122 may include the use of one or more cables, adapters, docking stations, base stations, charging stations, ports, interfaces, or connections, not shown but known to those of skill in the art.

In some embodiments, data processing system 100 does not include all elements described above, but functions as a dedicated docking or charging station for mobile device 150, so long as it includes a processor 102 and accessible memory 108 and other elements sufficient to perform the functions described herein.

Various disclosed embodiments allow the dynamic replacement of the encryption keys or other values used in a security algorithm, storing them for a short period of time. Mobile devices typically must be returned to a base station to be recharged or synchronized and are often replaced in their base stations at the end of each transaction. The security values can then be replaced within the device and stored at the receiving station for encryption/decryption of transmitted data for the next period of time until the device is redocked.

A system as disclosed herein can also be used for devices that are used once only, such as some military weapon systems. The keys could be generated just prior to launch and used for any communications, such as guidance. This would deter the theft of key values since they are only short lived or not generated at all until communications are required.

In many systems, encryption is used for transmitted communications and dynamic keys are used in land-based solutions. The replacement of keys is done in predetermined time frames to prevent security breaches. Dynamic keys are also used in many two-factor authentication schemes for secure Internet sign on, such as Internet banking. This type of system puts a certain risk on these devices data transmissions if proper manual process is not followed to update these keys at frequent intervals.

Various disclosed embodiments pertain to dockable devices such as the mobile device 150 described above. The disclosed systems and methods tighten the security features between the mobile device transmission and its receiver base station, which can be implemented by a data processing system 100. In some embodiments, the base station is physically attached to the receiving station of the mobile device or the base station itself is the receiving device.

The device would have a connection to the docking station that would allow the upload and/or download of data to the base station. This connection could be one of the standard couplings on mobile phones, LAN connection, USB, serial, etc. A chip would be contained in the device capable of performing encryption and or decryption (dependant on whether two-way communications are required). The chip would contain a memory, such as a portion of volatile ram, that would contain a variable key or salt value (dependant on the encryption method used). When the device is docked the value of this key/salt value would be regenerated and uploaded to the device, this would in turn make the life of the key valid only the time the device was undocked, thus tightening security due to the short life of the key/salt value.

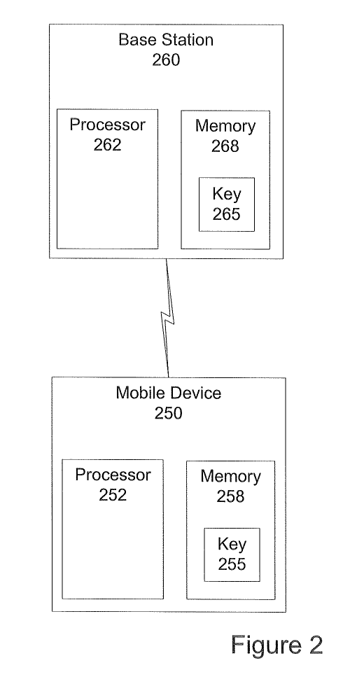

FIG. 2 depicts a simplified block diagram of a base station 260 in communication with a mobile device 250. Base station 260 includes processor 262 and memory 268, and key 265 is stored in memory 268. Mobile device 250 includes processor 252 and memory 258, and key 255 is stored in memory 258. Processors 262 and 252 can, in some embodiments, be implemented as a controller configured to perform the functions described herein.

As recognized by those of skill in the art, if symmetric encryption is used, key 265 can be the same as key 255. If asymmetric encryption is used, key 265 can be different than as key 255. Keys 255 and 265 can each be used to decrypt communications encrypted by the other key. While shown as single keys, keys 255 and 265 can represent multiple keys stored in the corresponding device. Keys 255 and 265 can also include or represent an encryption/decryption salt value. “Encryption key”, as used herein, can represent a key used for either encryption or corresponding decryption.

As described herein, according to at least one embodiment, mobile device 250 and base station 260 communicate wirelessly using communications encrypted/decrypted using keys 255 and 265, respectively. Base station 260 can also act as a charging/docking station for mobile device 250, and when attached or connected directly together, base station 260 and mobile device 250 can communicate using physical (i.e., non-wireless) communications in some embodiments.

Base station 260, in some embodiments, can correspond to data processing system 100, and mobile device 250, in some embodiments, can correspond to mobile device 150.

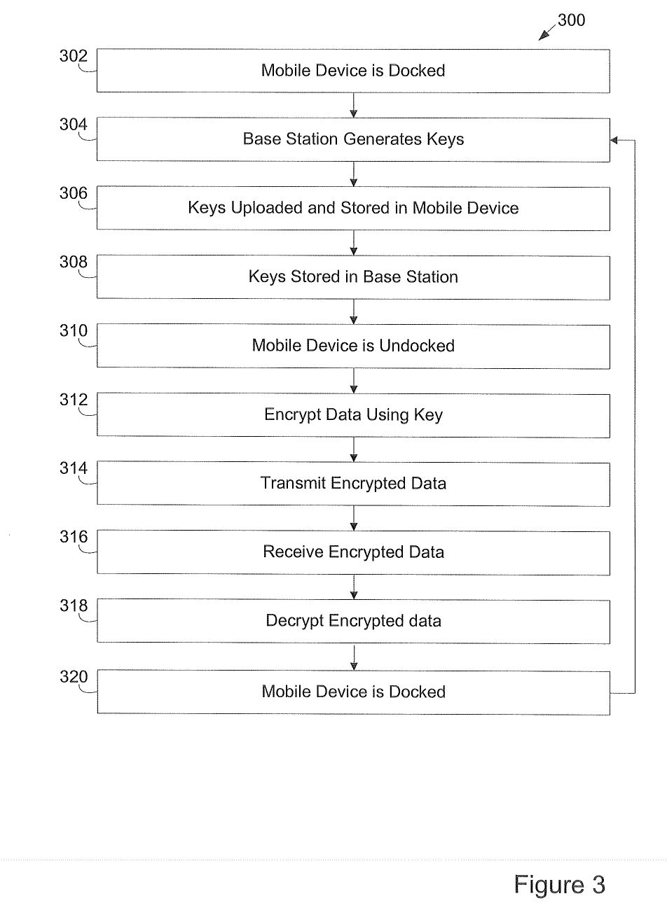

FIG. 3 depicts a flowchart of a process 300 in accordance with a disclosed embodiment. In this exemplary process, asymmetric encryption is used.

The mobile device 250 is docked in base station 260 and detected as docked by the base station 260 (step 302). In response, the controller 262 for the base station 260 generates a new key pair 255/265 (step 304). “Docked”, in this case, means connected to communicate directly with, preferably in a secure fashion, and preferably by a direct physical connection. “Docked” can also include physically housing or mounting the mobile device, and can include other functions such as electrically charging the mobile station.

Key 255 (e.g., a public key) is uploaded and stored in memory 258 of mobile device 250 (step 306). Corresponding key 265 (e.g., a private key) is stored in memory 268 of the base station 260 (step 308).

In some embodiments, particularly where two-way communications are used, then two key pairs are generated at step 304 and private key of the second pair is also uploaded and stored in memory 258 of mobile device 250 at step 306, and the corresponding public key is also stored in memory 268 of the base station 260 at step 308.

When the mobile device 250 is to be used, the user undocks the device (step 310) and performs any function allowed by mobile device 250.

Mobile device 250, using controller 252, encrypts the transmitted data using the stored public key 255 (step 312) then transmits the encrypted data to the receiver station (step 314). The transmitted data can include a device id corresponding to the mobile device 250, in encrypted or non-encrypted form.

The encrypted data is received by the base station 260 (step 316) and decrypted by controller 262 using of the stored private key 265 (step 318). The decrypted data is used in any manner required by the system. This is repeated for the required number of transmission by the device. If two-way communication is required, then the reverse encryption/decryption would occur for data transmitted from the base station 260 to mobile device 250.

When the user has completed use of the mobile device 250, the device is returned to base station 260 and detected as docked by the base station 260 (step 320). The process repeats at step 304, replacing the keys as described above. This makes the key very short lived and very difficult to penetrate thus reducing the vulnerability of the transmissions. Any key pair would only be valid for the time the device was undocked and, in some embodiments, the keys are never transmitted wirelessly. In some embodiments, all key exchanges are done over a closed network.

In an alternate embodiment, the base station 260 only performs non-wireless functions, e.g. key generation and loading, charging, docking, synchronizing, etc., and a separate receiving station is used for communicating wirelessly with the mobile device 250. In this case, the generated keys for the receiver side, instead or in addition to being stored in memory 258, are transmitted to be stored elsewhere to be used by the receiver station. For example, the keys could be transmitted to (e.g., over a network 130), stored in, and used by a receiver station, such as a cellular (or other wireless telephone system) base station or WiFi access point, and associated with a device ID corresponding to mobile device 250, so that the receiver station can communicate securely with mobile device 250. Alternately, the device ID and keys can be transmitted to and stored in a server 140, where they can be retrieved as needed by a receiving station connected to a network 130.

In the case of symmetric encryption such as 3DES, the stored values on the device and the base station can include a generated salt value (the size of which would be determined by the desired level of encryption).

Those of skill in the art will recognize that these techniques can be used for with any known encryption standard, as well as those developed in the future, wherever encryption keys are used.

A system such as that disclosed herein could be used, for example, by a secure facility inventory where the mobile device is a handheld scanner for reading inventory tags. Such a scanner could use the disclosed techniques for securely transmitting secure stock information from the warehouse floor to the inventory database.

Mobile police fingerprint/facial recognition devices could also use the disclosed techniques to secure the transmission and reception of sensitive personal record information to vehicles or hand held devices.

Military battlefield hand held units could deploy this technology to secure the battlefield control information. A missile launcher could use this technology to generate keys at launch time to secure all transmissions between the missile and base station.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the Context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC § 112 unless the exact words “means for” are followed by a participle.

What is claimed is:

1. A method, comprising:
detecting, by a base station, a mobile device docked with the base station;
in response to the detecting, generating at least one encryption key in the base station;
transmitting the encryption key to the mobile station by the base station while the mobile device is docked with the base station; and
communicating encrypted data with the mobile station, the encrypted data corresponding to the encryption key.

2. The method of claim 1, further comprising storing a second encryption key in the base station.

3. The method of claim 2, further comprising receiving second encrypted data from the mobile station and decrypting the second encrypted data using the second encryption key.

4. The method of claim 1, further comprising encrypting data, in the base station, that can be decrypted using the encryption key.

5. The method of claim 1, further comprising storing the encryption key in the mobile device.

6. The method of claim 1, wherein generating at least one encryption key includes generating at least one asymmetric encryption key pair.

7. The method of claim 1, further comprising storing a device ID corresponding to the mobile device.

8. The method of claim 1, wherein the generating and transmitting steps are repeated whenever the mobile device is re-docked in the base station.

9. The method of claim 1, further comprising transmitting a device ID and at least one encryption key to a server system.

10. The method of claim 1, further retrieving the encryption key from the server system by a receiver station.

11. A secure communications system comprising a base station and a mobile station, the base station configured to perform the steps of:
detecting a mobile device docked with the base station;
in response to the detecting, generating at least one encryption key using a controller;
transmitting the encryption key to the mobile station by the base station while the mobile device is docked with the base station; and
communicating encrypted data with the mobile station, the encrypted data corresponding to the encryption key.

12. The secure communications system of claim 11, the base station further configured to store a second encryption key in a memory in the base station.

13. The secure communications system of claim 12, the base station further configured to receive second encrypted data from the mobile station and decrypt the second encrypted data using the second encryption key.

14. The secure communications system of claim 11, the base station further configured to encrypt data that can be decrypted using the encryption key.

15. The secure communications system of claim 11, the mobile device configured to store the encryption key in the mobile device.

16. The secure communications system of claim 11, wherein generating at least one encryption key includes generating at least one asymmetric encryption key pair.

17. The secure communications system of claim 11, the base station further configured to store a device ID corresponding to the mobile device.

18. The secure communications system of claim 11, wherein the base station is configured to repeat the generating and transmitting steps whenever the mobile device is re-docked in the base station.

19. The secure communications system of claim 11, the base station further configured to transmit a device ID and at least one encryption key to a server system.

20. The secure communications system of claim 11, further comprising a receiver station configured to retrieve the encryption key from the server system.
